(19) United States
(12) Patent Application Publication
(10) Pub. No.: US 2004/0192371 A1
(43) Pub. Date: Sep. 30, 2004

(54) Method and system for power control during the traffic channel initialization period in a CDMA network

(75) Inventors: Wen Zhao, Kanata (CA); Jin Xin, Ottawa (CA)

Correspondence Address: SCHEEF & STONE, L.L.P., 5956 SHERRY LANE, SUITE 1400, DALLAS, TX, 75225, US

(73) Assignee: Research in Motion Limited

(21) Appl. No.: 10/807,957

(22) Filed: Mar. 24, 2004

(30) Foreign Application Priority Data
Mar. 24, 2003 (WO) PCT/CA03/00420

(51) Int. Cl. H04B 7/00

(52) U.S. Cl. 455/522; 455/69

(57) ABSTRACT

A method and system of controlling transmit power of a forward link signal between a basestation and a mobile device in a communications network, the method comprising the steps of: sending a first signal from the basestation to the mobile device, the first signal having a first signal transmit power; receiving the first signal at the mobile device; measuring the first signal for a received signal to noise ratio at the mobile device; sending a second signal from the mobile device to the basestation, the second signal containing information about the received signal to noise ratio; and setting the transmit power of the forward link signal based on the received signal to noise ratio information and the first signal transmit power, whereby if the received signal to noise ratio is high the setting step sets the transmit power of the forward link signal lower, and if the received signal to noise ratio is low the setting step sets the transmit power of the forward link signal higher.

### RELATED APPLICATIONS

This application claims priority from application PCT/CA/03/00420 filed Mar. 24, 2003.

### FIELD OF THE INVENTION

The present invention relates to forward link power control in CDMA wireless networks, and more particularly relates to forward link power control during the traffic channel initialization period.

### BACKGROUND TO THE INVENTION

In current CDMA wireless networks, mobile devices generally get access to the wireless networks through access channels in the reverse link, and the wireless network grants a mobile device access through paging channels. The mobile device and basestation then utilize a traffic channel to send and receive voice and/or data traffic.

When the mobile device first goes to the traffic channel, both the mobile device and the basestation usually start with preambles to become acquired and synchronized. The initial transmission power for the preamble from the mobile device is based on an open loop power control and the last successful access probe power level. Conversely, the initial transmission power level for the basestation is generally based on heuristic knowledge and is usually fixed at a predetermined value.

By using a predetermined value for the preamble transmission from the basestation, one of two problems can occur. If the power level is too low, the mobile device can fail to acquire the preambles transmitted by the basestation. Too low power can, for example, be caused by fading or territorial variations; narrow band interference (e.g. AMPS) seen in adjacent channels in the forward link or in neighboring cell/sectors; or an unbalanced RF link in some areas that cannot be fully optimized by network planning and optimization. The power level being too low leads to network access failure, and leads the mobile device to declare that the call cannot be successfully established.

In order to alleviate the above problems, the basestation usually sets the initial traffic channel transmit power to a relatively high level. This leads to the second problem, which is the loss of network capacity. By using high power levels, fewer calls can exist on the network, leading to sub-optimal network utilization.

### SUMMARY OF THE INVENTION

The present method and system seek to overcome the above problems by having the mobile device report to the basestation the received signal to noise ratio of a basestation transmitted signal. Based on the value of this received signal to noise ratio the basestation can adjust the power of the preamble in the traffic channel, thereby ensuring that the power level is optimal on a per user basis.

In a preferred embodiment the signal to noise ratio is measured from a known signal component, where the signal component measured is preferably the pilot signal from the basestation and the said signal to noise ratio is preferably expressed as the Ec/lo of the pilot channel, i.e., the energy per chip to the interference density ratio.

The present invention therefore provides a method of controlling transmit power of a forward link signal between a basestation and a mobile device in a communications network, said method comprising the steps of: sending a first signal from the basestation to the mobile device, said first signal having a first signal transmit power; receiving the first signal at the mobile device; measuring the first signal for a received signal to noise ratio at the mobile device; sending a second signal from the mobile device to the basestation, the second signal containing information about the received signal to noise ratio; and setting the transmit power of the forward link signal based on the received signal to noise ratio information and the first signal transmit power, whereby if said received signal to noise ratio is high said setting step sets the transmit power of the forward link signal lower, and if said received signal to noise ratio is low said setting step sets the third signal transmit power of the forward link signal higher.

The present invention further provides a system for controlling transmit power of a forward link signal in a communications network, said system comprising: a mobile device, said mobile device adapted to: receive a first signal from a basestation; evaluate a signal to noise ratio of the first signal; and transmit information about the received signal to noise ratio to said basestation; and the basestation, said basestation being adapted to: send said first signal with a first signal transmit power; receive said information about the received signal to noise ratio; and set the transmit power of said forward link signal based on said information about the received signal to noise ratio and said first signal transmit power, whereby if said signal to noise ratio is too high the basestation sets the transmit power of the forward link signal lower than the first signal transmit power, and if said signal to noise ratio is too low the basestation sets the transmit power of the forward link signal higher than the first signal transmit power.

### BRIEF DESCRIPTION OF THE DRAWINGS

The present invention is better illustrated in the drawings, in which:

FIG. 1 is a schematic view of the method of the present invention; and

FIG. 2 is a schematic view of the system of the present invention.

### DETAILED DESCRIPTION

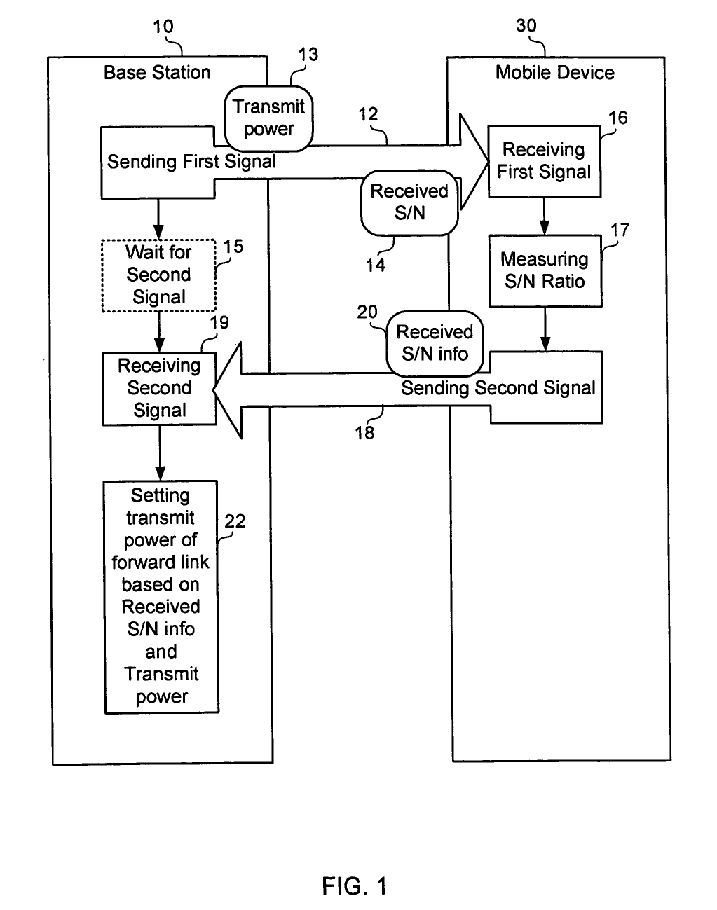

Reference is now made to FIG. 1. During the traffic channel initialization period, a basestation 10 and mobile device 30 send a sequence of a known pattern such as zeros in a traffic channel to each other as a preamble in order to get acquired and synchronized. The transmit power of the preamble from the basestation 10 to the mobile device 30 needs to be sufficiently high to ensure the mobile device receives and can correctly acquire the signal, but cannot be too high or network capacity is reduced.

Basestation 10 broadcasts a first signal 12 to any mobile device 30 within its transmission area. The basestation 10 knows the transmit power 13 of this first signal 12. Once this first signal is sent, the basestation waits in waiting step 15 for a second signal to be recieved.

When the mobile device 30 accesses the wireless network, it receives the first signal 12 from the basestation 10 in receiving step 16. In the present invention the mobile device 30 then evaluates the signal to noise ratio 14 of a given signal component of this received first signal 12 in measuring step 17 and sends this information 20 to the basestation 10. The signal component can be any component the base station 10 knows the level of, and in a preferred embodiment the signal component is the pilot channel. The evaluated information 20 is the signal to noise ratio or signal to interference or any other quantity that is proportional to the said ratio, e.g., the energy per chip to the interference density, i.e., the Ec/lo, of the pilot channel. This information can also be expressed in logarithmic scale format, e.g., in dB, or a form proportional to it.

The report for the signal to noise ratio can be sent from the mobile device 30 to the basestation 10 through a second signal 18, which is any reverse channel message received by receiving second signal step 19 at the basestation 10. Preferably, however, this report is sent through access channel signaling messages in order to provide the basestation 10 with the received signal to noise ratio prior to any traffic channel messages being sent.

Once the basestation 10 receives the report from the mobile station 30, it performs a setting step 22 to adjust its initial forward link preamble transmit power according to the reported signal to noise ratio 20 at the mobile device 30. In this way the transmit power of the preamble is optimized to the current network conditions including interference, fading or unbalanced RF links, particularly for the intended mobile device.

In the preferred embodiment where the measured signal to noise ratio is measured based on the Ec/lo of the pilot channel, the transmit power of the forward link preamble can be set according to the following formula:

initial_preamble_{—}pwr=pilot_{—}pwr+(desired_preamble_{—}Eclo−pilot_{—}Eclo)+delta

where:

initial_preamble_pwr is the transmitted power value for the targeted receiver in dBm (or in dB relative to a given reference);

pilot_pwr is the basestation transmitted pilot power in dBm (or in dB relative to a given reference);

desired_preamble_Eclo is the desired value of preamble Ec/lo in dB seen at the mobile device that is optimized for network performance criteria (for example, it is the lowest possible Ec/lo value at which receivers in the network can successfully acquire the preamble with sufficiently high probability);

pilot_Eclo is the pilot Ec/lo value in dB that the mobile device has estimated and reported to the base station during access to the network; and

delta is an offset parameter in dB whose value can be chose by the operator of the wireless network to optimize the initial_preamble_pwr according to the operator's network optimization policy, including accounting for the estimation error of the pilot_Eclo and possible channel condition changes since the mobile reports the pilot_Eclo, where in most cases a value of zero can be used, and usually is within the range of 0 to 6 dB.

Alternatively, in the above formula the initial_preamble_pwr and the pilot_pwr can be interpreted as gains in dB that are used in the basestation 10 transmitter to control corresponding signal, components, i.e. the preamble and the pilot.

The application of the above formula thus allows the basestation 10 to adjust the power of the preamble in the traffic channel based on data on a signal 12 received by a mobile device 10, thereby ensuring that the power level is optimal and eliminating the need for heuristic settings for the power level.

In an alternative embodiment, the desired_preamble_Eclo may be replaced by a desired_preamble_Eclo_by_mobile, which is the preamble Eclo that the mobile device 30 prefers. The reason for using the alternative value is that different manufacturers, or even different devices made by the same manufacturer, use different signal processing algorithms, and the capability of acquiring these signals may be different for different types of mobile devices 30. It is therefore desirable to have the individual mobile device 30 report its desired preamble Eclo. In this embodiment the desired_preamble_Eclo_by_mobile is preferably reported through the same signal 18 used to report the pilot_Eclo.

Once the basestation 10 receives the desired_preamble_Eclo_by_mobile it can either use this value or the predetermined desired_preamble_Eclo in the above formula. The selection may be determined by the function:

If desired_preamble_Eclo_by_mobile>desired_preamble_Eclo then use desired_preamble_Eclo_by_mobile, otherwise use desired_preamble_Eclo

The above function is biased to obtain a better rate of successfully acquiring the signal. A built in check is also possible, where if the desired_preamble_Eclo_by_mobile is too high to accept, it is treated as an illegal value and a maximum acceptable value is instead used by the basestation.

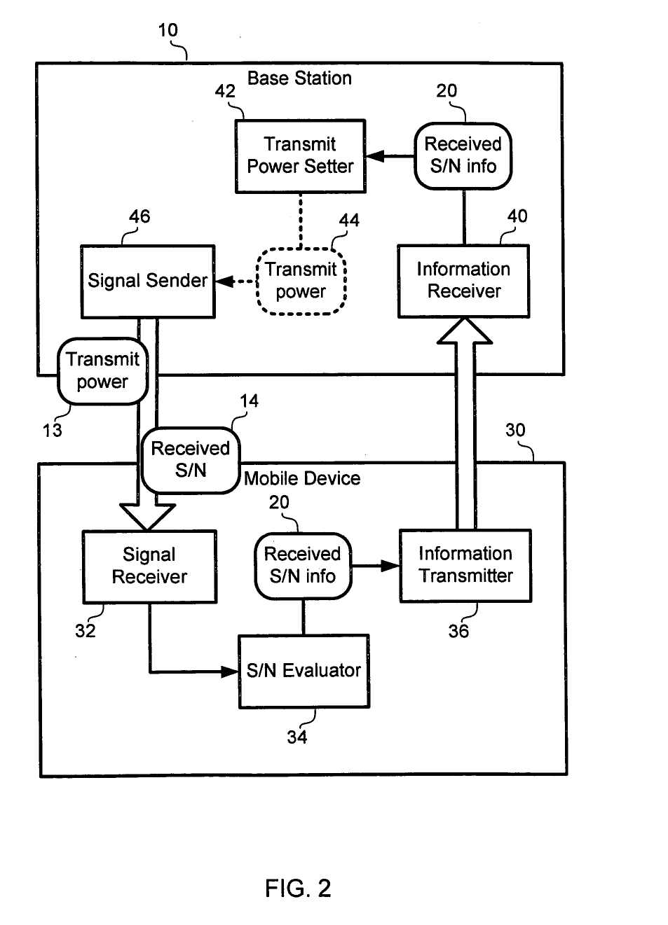

Reference is now made to FIG. 2. A system for implementing the above includes a mobile device 30 that is adapted to receive a signal component such as the pilot channel at a signal receiver 32 and to evaluate the signal to noise ratio 14 of this signal component at signal to noise ratio evaluator 34. The mobile device 30 can then send this information 20 using information transmitter 36 to a basestation 10.

The basestation 10 is adapted to receive the information 20 from mobile device 30 at information receiver 40 and to set the transmit power of the preamble for mobile device 10 at power setter 42 to a level 44 based on the received signal to noise ratio. The preamble is transmitted in a traffic channel using signal sender 46, and the power level corresponds to the pilot signal power adjusted based on the above formula.

While the present invention contemplates preamble power control in a CDMA network, one skilled in the art will realize that the present method and system can be used in other types of networks and for signals other than the preamble.

The above-described embodiments of the present invention are meant to be illustrative of preferred embodiments and are not intended to limit the scope of the present invention. Also, various modifications, which would be readily apparent to one skilled in the art, are intended to be within the scope of the present invention. The only limitations to the scope of the present invention are set forth in the following claims appended hereto.

We claim:

1. A method of controlling the transmit power of a forward link signal between a basestation and a mobile device in a communications network, said method comprising the steps of:
sending a first signal from the basestation to the mobile device, said first signal having a first signal transmit power;
receiving said first signal at the mobile device;
measuring said first signal for a received signal to noise ratio at the mobile device;
sending a second signal from the mobile device to the basestation, said second signal containing information about said received signal to noise ratio; and
setting the transmit power of the forward link signal based on said received signal to noise ratio information and said first signal transmit power, said setting step including:
estimating a signal component value based on said received signal to noise ratio;
calculating the difference between a desired signal component value and said estimated signal component value; and
assigning the transmit power of said forward link signal to a value obtained by offsetting said first signal transmit power by the difference found in said calculation step.

2. The method of claim 1, wherein said method is performed during a traffic initialization period between said basestation and said mobile device.

3. The method of claim 1, wherein said forward link signal is a preamble sent from said basestation to said mobile device.

4. The method of claim 1, wherein said first signal is a pilot signal.

5. The method of claim 1, wherein the step of sending said second signal is performed over an access channel in the communications network.

6. The method of claim 1, wherein said desired signal component value is a pre-optimized preamble Ec/lo value.

7. The method of claim 1, wherein the desired signal component value is determined based on said mobile device.

8. The method of claim 7, wherein the desired signal component value is reported to said basestation during said sending said second signal step.

9. The method of claim 7, wherein the desired signal component value is limited by a threshold value, whereby if said value based on said mobile device exceeds said threshold value, said desired signal component value is set to said threshold value.

10. The method of claim 1, wherein the desired signal component value is selected from a predetermined value at said basestation and a value received from said mobile device.

11. The method of claim 10, wherein said selecting is performed based on the higher value between said predetermined value at said basestation and said value received from said mobile device.

12. The method of claim 11, wherein said selecting is limited by a threshold value, whereby if said value received from said mobile device exceeds said threshold value, said selecting step uses said threshold value.

13. The method of claim 1, wherein said setting step further includes adding an offset value to the transmit power of said forward link signal.

14. The method of claim 13, wherein said offset is between 0 and 6 dB.

15. The method of claim 1, wherein said estimated signal component value is an estimated Ec/lo value of said first signal.

16. The method of claim 1, wherein said communications network is a CDMA network.

17. A system for controlling transmit power of a forward link signal in a communications network, said system comprising:
a mobile device, said mobile device adapted to:
receive a first signal from a basestation;
evaluate a signal to noise ratio of said first signal; and
transmit information about said received signal to noise ratio to said basestation; and
said basestation, said basestation being adapted to:
send said first signal with a first signal transmit power;
receive said information about the received signal to noise ratio from said mobile device; and
set the transmit power of said forward link signal based on said information about said received signal to noise ratio and said first signal transmit power, said setting of the transmit power in said basestation including:
estimating a value of a signal component of said first signal based on said information about the received signal to noise ratio;
determining a desired value for said signal component; and
setting the transmit power of said forward link signal by adding the difference between the desired signal component value and the estimated signal component value to the first signal transmit power.

18. The system of claim 17, wherein said first signal is a pilot signal.

19. The system of claim 17, wherein said transmitting of information from said mobile device is performed over an access channel.

20. The system of claim 17, wherein said forward link signal is a preamble on a traffic channel sent from said basestation to said mobile device.

21. The system of claim 17, wherein said setting of the transmit power in said basestation is performed during a traffic initialization period between said basestation and said mobile device.

22. The system of claim 17 wherein said evaluating of said first signal in said mobile device is performed on a first signal component.

23. The system of claim 22, wherein the first signal component is the Ec/lo of the first signal.

24. The system of claim 17, wherein said determining said desired signal component value is based on a pre-optimized preamble Ec/lo value.

25. The system of claim 17, wherein said determining said desired signal component value is based on said mobile device.

26. The system of claim 25, wherein said desired signal component value is reported to said basestation during said transmitting of information step.

27. The system of claim 25, wherein the desired signal component value is limited by a threshold value, whereby if said value based on said mobile device exceeds said threshold value, said desired signal component value is set to said threshold value.

28. The system of claim 17, wherein the desired signal component value is selected from a predetermined value at said basestation and a value received from said mobile device.

29. The system of claim 28, wherein said selecting is performed based on the higher value between said predetermined value at said basestation and said value received from said mobile device.

30. The system of claim 29, wherein said selecting is limited by a threshold value, whereby if said value received from said mobile device exceeds said threshold value, said selecting step uses said threshold value.

31. The system of claim 17 wherein said setting further includes adding an offset parameter to the transmit power of said forward link signal.

32. The system of claim 31, wherein the value of the offset parameter is between 0 and 6 dB.

35. The system of claim 17 wherein said communications network is a CDMA network.
